(19) United States
(12) Patent Application Publication
(10) Pub. No.: US 2010/0170834 A1
(43) Pub. Date: Jul. 8, 2010

(54) Portable fluid filtration device

(75) Inventors: D. Redwood Stephens, Seattle, WA (US); Earl Sherrard, Ravensdale, WA (US); Josh Buesseler, Seattle, WA (US); Lee Getzewich, Issaquah, WA (US)

Correspondence Address: STEPHEN M. EVANS;GRAYBEAL JACKSON LLP, Suite 350, 155-108th Avenue NE, Bellevue, WA, 98004-5901, US

(73) Assignee: Cascade Designs, Inc., Seattle, WA (US)

(21) Appl. No.: 12/586,467

(22) Filed: Sep. 21, 2009

Related U.S. Application Data
(63) Continuation of application No. PCT/US2008/003773, filed on Mar. 20, 2008.
(60) Provisional application No. 60/919,285, filed on Mar. 20, 2007.

(51) Int. Cl. B01D 29/52; B01D 29/60; B01D 29/66

(52) U.S. Cl. 210/108; 210/346; 210/136

(57) ABSTRACT

Portable apparatus, systems and methods for the selective removal of contaminants from a fluid medium through the use of hollow fiber media (“HFM”). Apparatus embodiments include a housing defining an inlet portion, an outlet portion and a chamber fluidly coupled there between for receiving hollow fiber media, in either bulk or cartridge form, wherein the media is hydrophilic and/or hydrophobic. Passive, i.e., gravity fed or active, i.e., mechanically pressurized versions are disclosed. Apparatus may further include user reversible/replaceable check valves, a receptacle fitting adaptor to allow the use of a variety of receiving containers with a single filtration device, and configurations wherein at least 80% of a maximum flow rate through the filter can be achieved when an inlet fluid pressure is about 0.2 bar. A buoyant pre-filter with an optional hydrophilic filter element may also be used to establish a system.

### BACKGROUND

Comprising on average 60 percent of a person's weight, water is the human body's principal chemical element. Lack of water can lead to dehydration, a serious condition occurring when a person loses more water than he or she consumes. When dehydration occurs, the level of water in the body is below that level necessary for normal body function. A loss of merely ten percent of a body's water can cause the onset of severe bodily disorders; a twenty percent loss can cause death. To prevent dehydration, it is imperative that water be consumed regularly at intervals frequent enough to replace water lost through elimination, perspiration and respiration.

Despite three-fourths of the world's surface being covered in water, finding water outside of a municipality, a developed country, or certainly in wilderness environments that is potable can be challenging. Freshwater that is not treated chemically and/or filtered cannot be assumed potable as a large percentage of such water is microbiologically unfit for consumption, containing any myriad of harmful protozoa such as giardia or cryptosporidium. Hence, whether hiker, climber, or third-world adventurer, to keep oneself hydrated outside the ambit where treated water exists in abundance, it is imperative that travelers bring with them a portable means for filtering suspect water.

The current art, as a solution to the need for a portable water filtering system, teaches toward the use of hand pumping devices coupled with any of a variety of proven filtering media, including: ceramic, plastic, glass-fiber, and so on. An inherent problem in these types of filters, however, is low volumetric flux due to the small flow area of the art's currently utilized filters; i.e., total water discharge through a porous medium is dependent on the surface area of porous media flow (as well as the porosity and pore distribution), which in most traditional filtering media is small relative to the amount of water desired filtered over a short period of time.

### SUMMARY OF THE INVENTION

The invention is directed to components and systems, as well as related methods, for selective removal of contaminants from a fluid medium through the use of hollow fiber media (“HFM”). Apparatus embodiments of the invention are directed to a filtration device comprising HFM. Filtration devices according to embodiments of the invention comprise a housing defining an inlet portion, an outlet portion and a chamber for receiving hollow fiber media wherein the inlet portion is fluidly coupled to the outlet portion via the chamber. Preferably, the inlet portion and outlet portion are arranged in conjunction with the housing and the chamber in such a manner so as to maximize exposure of HFM when disposed in the chamber. Depending upon design considerations, the inlet and outlet portions may be located at opposing ends of the housing, either axially or otherwise, or may be colocated at one end of the housing, either coaxially or otherwise.

The HFM may be directly disposed in the chamber or may be disposed in a cartridge, which is then located in the chamber, the later being preferred. Alternatively, the housing may comprise the cartridge. In particular, conventional cartridge embodiments provide the user with a convenient means for introducing and removing the media from the filtration device. Moreover, a greater amount of material and more efficient packing of the material can be obtained for a given volume through the use of dedicated packing equipment not otherwise available to a consumer or field user. Thus, a conventional filter cartridge having an internal diameter of about 1″ (2.54 cm) and height of about 4.5″ (11.43 cm) can be packed to have 1.6 ft² (0.149 m²) of effective filter surface area. This value equates to a ratio of about 785 ft² of filtration media per cubic foot (2575 m²/m³). By comparison, modern ceramic filter cartridges have ratios of about 24 ft² of filtration media per cubic foot (79 m²/m³).

Depending upon user needs, the invention may be characterized as passive, wherein gravity provides the motive force between the inlet portion and the outlet portion of the filter housing, or active, wherein mechanical pressurization of the fluid at the inlet portion effectuates filtration of the fluid and expulsion through the outlet portion. Passive embodiments have the advantage of simplicity: two fluid conduits and a filter chamber defined by the housing/cartridge and HFM filtration media; a fluid reservoir may be used to collect any filtered effluent. Because of the very low trans-filter pressure requirements when HFM is used (pressure drop), volumetric flow rates of about 1.75 l./min. can be achieved with 5.1 cubic inch (˜83 cm³) filter cartridges in passive embodiments when a suitable influent pressure head is developed, e.g., six (˜183 cm) vertical feet, which equates to about 2.6 lbs./in.² (˜0.18 bar).

In passive embodiments, a fluid pathway is established from a source of influent to the effluent reservoir. Preferably, the source of influent is an influent reservoir filled with fluid to be filtered. In such passive embodiments, a sufficient fluid pressure head at the inlet portion must be established to create a forward bias through the HFM. Therefore, a method of using such a system comprises establishing the source of influent gravitationally above the HFM and the effluent reservoir. This elevation differential causes a pressure head to form in the fluid, which causes the fluid to migrate from the influent conduit to the effluent conduit, without the aid of mechanical pressurization of the fluid.

Those persons skilled in the art will readily realize that the pressure head at the filter is determined by the total vertical distance between the influent and effluent reservoirs, presuming that the system is a closed system and no air is entrained therein (as detailed below, removal of entrained air is considered desirable and means/methods are provided for accomplishing this objective). Thus, maximum pressure is developed by maximizing the total vertical distance.

For many of the embodiments described herein, the total vertical differential is about 6 feet (˜183 cm). Given that the average height of a user is between about 5 and 6 feet (˜152 and ˜183 cm), this distance is attainable for most all users: If used, an influent reservoir may be positioned at or above the user's head such as by hanging or placing, and the effluent reservoir is placed on or proximate to the ground. When both conduits and filter are filled with fluid, then the maximum pressure head is reached. However, when only the influent conduit is filled with fluid, the pressure head is necessarily less than when both conduits are filled. Thus, it is considered desirable in a passive system to have a longer influent conduit in order to create sufficient pressure to overcome the trans-filter resistance (pressure drop) and fill the effluent conduit with fluid. However, the precise length of such conduit is influenced by other variables, such as the effluent conduit length, combined conduit lengths, filter dimensions, expulsion of air from the system, etc., which are well known to the skilled practitioner.

Because the pre-filter pressures developed in a passive system are not great compared to an active filtration system, it is important to minimize back pressure created by the filtration media. HFM is ideally suited for such applications insofar as it can have an exceptionally high surface area in a small volume. However, the efficacy and back pressure of HFM is strongly affected by the degree of material contamination and the presence of trapped air in the media. It is therefore desirable in many situations to effectuate a back flushing of the HFM in order to remove particulate matter. Moreover, trapped air during initial operation of passive systems embodying the invention adversely affects performance, and therefore should be mitigated. Back flushing the HFM further removes trapped air in the media and “primes” it for more efficient passage of fluid there through. Alternatively, a portion of the HFM may include hydrophobic hollow fibers that function to transport air across the filter media, thereby expelling such air into the outlet conduit.

Thus, a method of operating a passive filtration system according to certain embodiments of the invention comprises initially directing fluid from the inlet conduit through the HFM and to the outlet conduit, reversing the direction of fluid flow by causing at least the outlet conduit to be elevated above the inlet conduit, and finally reversing the elevations of the fluid conduits to generate forward fluid through the HFM. It should be noted that the inlet conduit is preferably in fluid communication with the influent during the described back flushing method to minimize the reintroduction of air into the system; however, if contaminant buildup is of primary concern, either the influent port or conduit can be exposed to the environment so that the contaminants are not reintroduced into the influent reservoir where they might again lodge in the HFM. In many embodiments described herein, effective back flushing of the HFM can take place in 2-3 seconds to purge trapped air. Back flushing of contaminants can occur in 20 seconds.

As noted above, active filtration embodiments utilize a pressure assist mechanism to increase trans-filter pressure beyond that obtainable through passive or gravity assist means. In these embodiments, where the HFM by necessity functions as a check valve, such filtration devices further comprise at least one valve means for providing unidirectional fluid flow under normal operating conditions, operatively located between the inlet portion and the outlet portion. As those persons skilled in the art will appreciate, the incorporation of means for providing unidirectional fluid flow is necessary in any pressurized pump system where backflow is to be prevented.

While active filtration embodiments of invention preferably use two unidirectional valves (e.g., an inlet check valve and an outlet check valve), desirable operation of such apparatus with only an inlet unidirectional valve is possible: once the HFM has been wetted, the surface tension or bubble point of the water in the HFM pores function as a unidirectional valve. In such embodiments, initial wetting of the HFM can be accomplished using gravity assist (as was the case in passive filtration embodiments), immersion, or any viable means for establishing a wetted media.

In many active filtration embodiments of the invention, the at least one valve means for providing unidirectional fluid flow under normal operating conditions is nominally closed at zero (Ø) differential pressure, and preferably functionally open at 0.5 to 1.0 psig of positive pressure. Such a valve may also find use in passive filtration embodiments or active filtration embodiments that may be used in a gravity biased mode.

While any mode of pressure assist is considered within the scope of the invention, certain embodiments of the invention utilize a telescoping pressurizing design. Because HFM creates a relatively low trans-filter resistance (pressure drop) to fluid flow, it is not necessary to use pressurizing designs that advance mechanical advantage (pressurization) over volumetric flow. Thus, pressurizing can be optimized for volumetric flow. This includes use of a filter cartridge containing the HFM as a piston or double action pumps (axial or lever) whereby fluid is passed through the HFM on both strokes, i.e., the “up” stroke as well as the “down” stroke.

Various embodiments of the invention further include a substantially buoyant inlet or pre-filter in addition to HFM disposed within the filtration device. Inlet filters are common in the art of portable water filtration apparatus, however, various invention embodiments use inlet filters that differ from the prior art. In particular, an inlet filter according to selected embodiments of the invention comprises a resilient and compressible body having a conduit coupler on one side thereof such that influent is caused to traverse the resilient and compressible body before entering the conduit coupler. The inlet filter may further comprise a mesh or screen positioned on a side of the body opposite the conduit coupler to act as a first stage filter element. Fine hydrophilic mesh screens in conjunction with low pressure differentials across the inlet filter eliminate air from entering the influent stream even when sections for the screen are not fully submersed in water. This feature is accomplished by the surface tension of the water in the pores of the screen being greater than the pressure differential across the screen. The composite inlet filter preferably has positive or neutral buoyancy.

In robust embodiments of the inlet filter, the body is partially enveloped by a fluid impervious panel such that the side opposite the conduit coupler is generally exposed to the environment, although other portions of the body may also be exposed. Beneficially, influent is directed through the body towards the conduit coupler, and the body is at least partially protected from damage by the panel. Moreover, if the panel extends beyond the boundary of the body, such extensions may be used to secure the mesh or screen, such that the body is fully enveloped by the mesh/screen and panel.

The selection of a resilient and compressible body, such as open cell foam, in combination with an optional crushable mesh/screen and/or panel, which may have hydrophilic properties, permits the user to compactly store the inlet filter when not in use, and yet still achieve large filtration surface areas. In addition, by acquiring influent at or proximate to the surface of a water source due to the filter's positive or neutral buoyancy, detritus and debris commonly found at or near the bottom of a water source can be avoided in the first place, thereby increasing the usability of the inlet filter and reducing the cleaning intervals.

Embodiments of the invention also may include numerous features intended to improve filtration and flow efficiency, usability and safety. One such feature is a mechanical freeze indicator. As users of filtration devices in freezing conditions well know, subjecting such devices to freezing conditions often results in mechanical failures caused by water expansion during phase transition to a solid (an approximately 9% coefficient of expansion). While often times the failure is obvious from basic device inspection and/or operation, more minor failures still do occur, often without user knowledge. A possible result of such minor failure is contamination of filtered effluent by the unfiltered influent, a consequence that the user would likely not immediately notice. Embodiments of the invention that employ a freeze indicator notify the user that a freezing condition has occurred, and that the filtration device may be compromised. The location of such indicator may be selected based upon material susceptibility, user risk exposure and/or convenience (manufacturing or user). An example of such an indicator comprises a bimetallic disc that physically distorts (such as through inversion) to trip a visual indicator that must be manually reset. Thus, once the indicator has been tripped, even if the disc reverts to its original, pre-freezing geometric configuration, the indicator will remain in the visually “tripped” state. Another example of such indicator comprises a sacrificial reservoir of water. When the water in the reservoir freezes, it either ruptures its container or again trips a visual indicator as was previously described. This feature can be found in either active or passive embodiments.

Another feature found in selected embodiments of the invention relates to the use of an inlet check valve with intrinsic pressure relief function in active filtration embodiments. In such embodiments, the filtration device includes an inlet check valve that is designed to momentarily fail when internal back pressure exceeds a certain value, such as 40 psig (˜2.76 bar). Thus, any component downstream of the pump arrangement, such as a filter cartridge, will not be exposed to pressurized fluid in excess of the predetermined value; the pressurized water will simply reverse flow though the inlet conduit. This feature is particularly available when the check valve comprises a duckbill or functionally similar valve. The use of an inlet check valve having this property also simplifies the construction of the device (a separate bypass circuit is not needed).

Still another feature found in selected embodiments of the invention relates to the manual reversibility of the filtration device check valve(s) to thereby modify the direction of fluid flow. By constructing the housing to permit manual reversal (direction) of the check valve(s), a reverse flow or back flushing operation can be undertaken in active embodiments without reliance on gravitationally assisted flow reversal.

Because filtered water is commonly stored for subsequence use, effluent exiting from the filtration device is optimally directed to a storage container. While there are common fluid containers available in the outdoor recreational market such as NAGALENE bottles, 1 and 2 liter soda bottles, collapsible hydration packs, etc., each form factor has a generally unique sealing interface; a cap from one will not functionally seal an opening of another. Therefore, a common solution has been to use flexible tubing from the outlet portion of a filter device to the mouth of the storage container. When the container becomes full, the tube is removed and the container sealed. While effective, this solution requires the user to store and maintain the tubing. Moreover, the mouths of certain containers are very large, which often results in spilling of contents during fluid removal procedures. Perhaps most significant, however, is that the fluid storage container must be stabilized during filling operations at the same time as the filtration device is being operated. Because operation of an active filtration device requires both hands of a user, the container must be stabilized by other means such as the user's feet or by way of objects. Failure to maintain container stabilization will often result in significant loss of filtered fluid.

Certain filtration apparatus embodiments of the invention provide a solution for this interface and usability dilemma. By directly and securely coupling the fluid storage container to the filtration device, one can dispense with an outlet conduit and ensure that the container is stabilized during filing due to its mechanical coupling with the filtration device. This is accomplished by a container adaptor or bushing comprising a first orifice adapted to securely engage the outlet portion of the filtration device, and a second orifice adapted to securely engage the mouth of a target fluid storage container. The engagement of the container adaptor or bushing with the filtration device is preferably secure, thereby preventing unintentional disengagement there between. A bayonet-type interface with the outlet portion is considered to be one example of a secure engagement means; such means are quick, secure, and less subject to failure due to particulate contamination.

The container adaptor or bushing may optionally include a tethered plug adapted to securely engage the first orifice when the first orifice is not engaged with the filtration device. In this manner, the container adaptor or bushing may replace the fluid storage closure element and be immediately matable to the filtration device. Moreover, if the first orifice is sized for optimal fluid consumption, prior art deficiencies associated with oversized container mouths can be overcome. While the plug interface with the first orifice need not be of the same type as the filtration device to first orifice interface, e.g., bayonet securement, the benefits derived from using one form likely apply to both.

A feature of the container adaptor or bushing according to the invention is the incorporation of multiple container interfaces at the second orifice. While the first orifice need only be matable to the filtration device, the second orifice desirably has more than a single fluid storage container interface. Alternatively or in addition to this feature, the outlet of the filtration device (or associated fluid carrying structure) may also be matable to one or more storage containers, even without the presence of the container adaptor or bushing, e.g., a portion of the outlet portion may have a frustoconical plug that compressively engages the interior surface of a soda bottle mouth through an interference fit, or a plurality of coaxial rings for engaging the interior surface of a soda bottle mouth. In either or both embodiments, use of a tube-based fluid conduit can be avoided, stability of the fluid container is ensured, and increased performance of the container may be achieved. Conversely, the outlet portion of the filtration device (or associated fluid carrying structure) may include a hose barb to receive a tube-based fluid conduit, e.g., a personal hydration system conduit. To maximize usability, robust embodiments of the invention will include all noted interfaces and caps.

### DESCRIPTION OF THE DRAWINGS

FIG. 1 is a perspective of a pump assembly embodiment of a filtration device according to the invention;

FIG. 2 is a side elevation view of the embodiment of FIG. 1;

FIG. 3 is a front end elevation view of the embodiment of FIG. 1;

FIG. 4 is bottom plan view of the embodiment of FIG. 1;

FIG. 5 is a side elevation view in cross section of the embodiment shown in FIG. 1, and also having an adaptor or bushing attached to the outlet fitting;

FIG. 6 is perspective view of the embodiment of FIG. 1, further including an adaptor or bushing attached to the outlet fitting and a pre-filter fluidly coupled to the pump assembly via a hose;

FIG. 7 is a rear end elevation of the embodiment of FIG. 6;

FIG. 8 is a front end elevation of the embodiment of FIG. 6; and

FIG. 9 a perspective view, in cut away of the pre filter illustrates a second filter of FIGS. 6-8.

### DETAILED DESCRIPTION OF INVENTION EMBODIMENTS

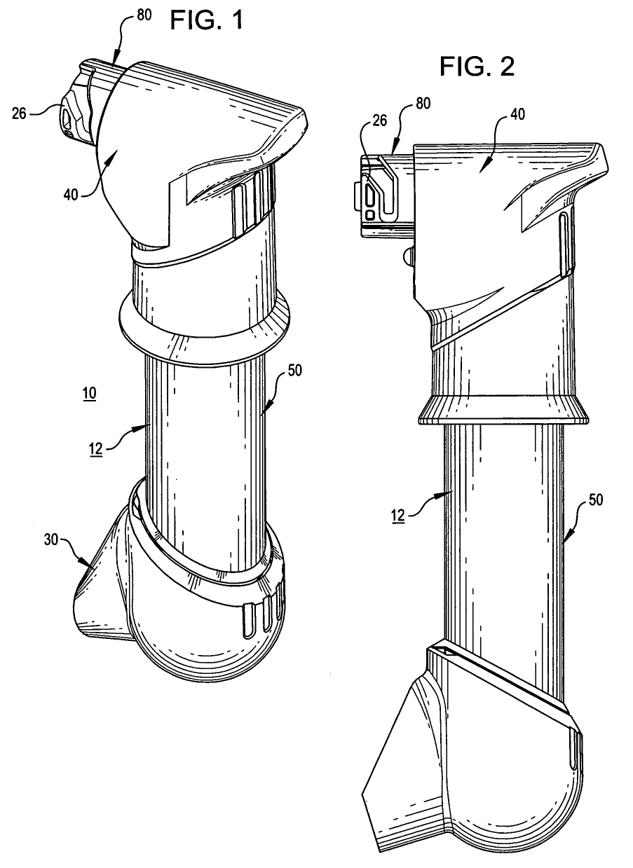

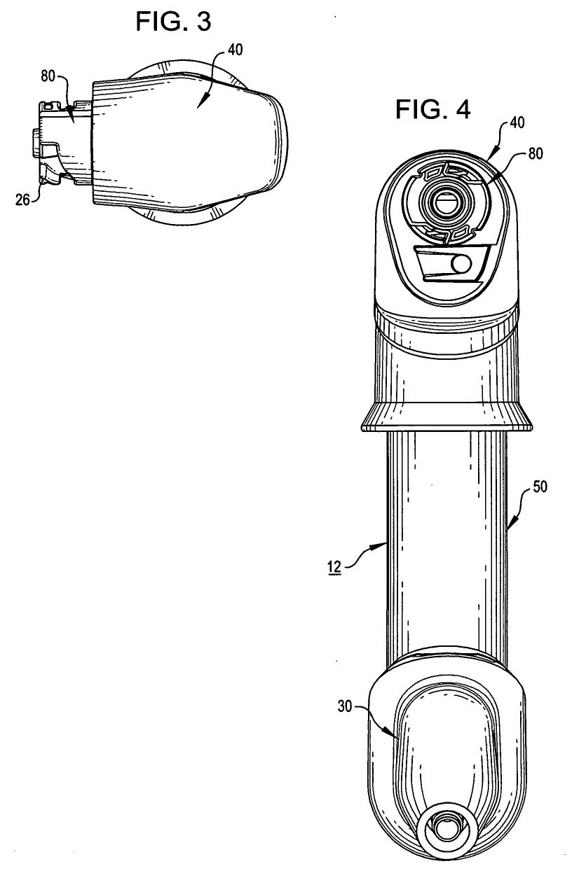

Turning then to the several Figures wherein like parts are similarly numbered, and more particularly to FIG. 1, a first embodiment of the invention is shown in perspective. Unless otherwise noted, all parts are preferably formed from plastic or similar lightweight yet strong material. As shown, portable filtration device 10 includes pump assembly 12, which in turn includes the following major components: inlet portion 30, outlet portion 40, and body portion 50. FIGS. 2, 3 and 4 provide alternative view of the exterior of pump assembly 12.

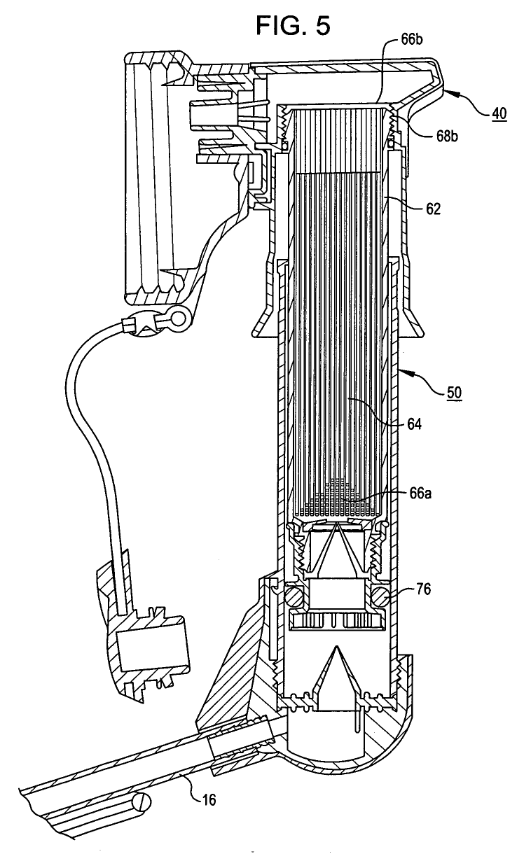

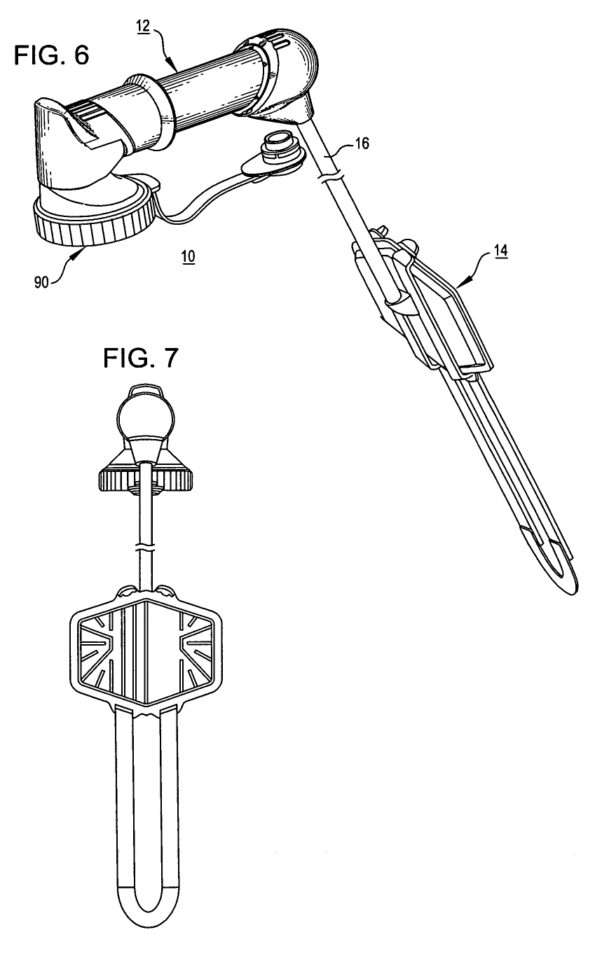

Referring to FIG. 5, the internal components of pump assembly 12 are shown. Inlet portion 30 includes inlet hose insert into which one end of hose 16 may be coupled (see, for example, FIG. 6). Inlet portion 30 defines inlet cavity 34, which provides a volume in which incoming fluid may reside before being biased towards filter cartridge 60, but more particularly provide sufficient space to accommodate directional reversal of inlet check valve 52 for reasons previously described. Additionally inlet portion 30 provides internal threads 36, which as will be described below, function to engage with corresponding structure on body portion 50.

Pump assembly 12 further includes outlet portion 40, which defines outlet orifice 42 and outlet cavity 44. Outlet orifice 42 is sized to receive outlet fitting 80, which may be permanently installed thereat, or removably installed. Additionally, outlet portion 40 provides internal threads 46, which as will also be discussed below, function to engage with corresponding structure on filter cartridge 60. Also defined by outlet portion 40 is spring tab recess 48.

Threadably coupled to inlet portion 30 is body portion 50, which primarily functions to a) provide supporting structure for inlet check valve 52, comprising opposing resilient members 54a and 54b as well as outlet check valve 56, comprising opposing resilient members 58a and 58b; and b) receiving means for a portion of filter cartridge 60. The noted receiving means provides circumferential (coaxial) support for filter cartridge 60 as well as coaxial alignment with outlet portion 40 during telescopic reciprocation to generate an inlet to outlet fluid pressure bias.

Filter cartridge 60 operatively links inlet portion 30 with outlet portion 40 in combination with carrier 70. Carrier 70 provides carrier housing 72, which includes guard 74, O-ring 76 to limit fluid travel to only outlet check valve 56, and internal threads 78, which engage with external threads 68a of filter cartridge 60. Note that guard 74 provides sufficient space to permit outlet valve 56 to be directionally reversed, thereby facilitating assisted back flushing of device 10. Filter cartridge 60 in turn comprises cartridge housing 62, a plurality of hollow fibers that comprise the HFM, influent end 66a and effluent end 66b, as well as previously described external threads 68a and 68b. Both influent end 66a and effluent end 66b are exposed, thereby permitting fluid to flow from one end to the other end, but necessarily through the HFM.

In the disclosed embodiment, the HFM comprises a combination of hydrophilic and hydrophobic fibers. Exemplary hydrophilic fibers are constructed from polysulphone (a/k/a polysulfone), and can be purchased under the trade names of UDEL and HYVEX; exemplary hydrophobic fibers are constructed from polyethylene, and are commonly available for a variety of manufacturers. The fibers preferably have an external diameter of about 0.5 mm and a nominal wall thickness of 0.1 mm.

In many embodiments of the invention, such as in the example disclosed in detail herein, a heterogeneous mix of hydrophilic and hydrophobic fibers are used, with a predominant presence of hydrophilic fibers. While hydrophilic fibers excel in the transport of fluids, which in this case is mostly water, such fibers actually function as a form of barrier to the passage of air. As noted previously, until pump assembly 12 has been primed, or after reverse flushing actions, it may be necessary to “bleed” trapped air from the system to establish proper operation. Thus, hydrophobic fibers are used in conjunction with hydrophilic fibers to transport undesired air out of pump assembly 12.

Pump assembly 12 also includes outlet fitting 80, which is fluidly coupled to outlet orifice 42. As also shown in FIGS. 1-4, outlet fitting 80 comprises hose barb 82, which is intended to accept a flexible conduit such as a rubber or polyethylene hose; small neck bottle interface 84, which is intended to rotationally couple with conventional beverage containers such as 0.5, 1.0 and 2.0 liter containers as well as others; bayonet interface, which is intended to provide a linking means for accepting adaptor or bushing 90 (described below); and locking spring tab 88, which is accepted by adaptor or bushing 90 to prevent unintended rotation of the same relative to pump assembly 12.

In operation, inlet portion 30 is extended away from outlet portion 30 (and/or vice versa), thereby expanding the volume between inlet check valve 52 and outlet check valve 56. Consequently, low pressure forms there between, which causes inlet check valve to open, and draw influent through hose 16. Over extension is prevented by a return present on body portion 50 interfering with a portion of carrier 70. Upon pressure equalization, inlet check valve 52 closes. When inlet portion 30 and outlet portion 40 are adducted, the pressure bias reverses, causing influent to exit outlet check valve 56 and into filter cartridge 60. After passing through cartridge 60, the resulting effluent enters outlet cavity 44 and is expelled through outlet fitting 80.

To provide a positive fitment between pump assembly 12 and an effluent reservoir, adaptor or bushing 90 may be used, as is shown in FIGS. 5-7. This component defines bayonet interface 92, which is complementary to bayonet interface 86 of outlet fitting 80. By attaching adaptor or bushing 90 to pump assembly 12, one can use wide neck bottle interface 94 in addition to the interfaces provided by outlet fitting 80. Moreover, adaptor or bushing 90 further includes tethered cap 98, which serves to insulate outlet fitting 80 from the environment. As noted above, it may also be detached from pump assembly 12 and separately replace a conventional wide neck bottle closure element.

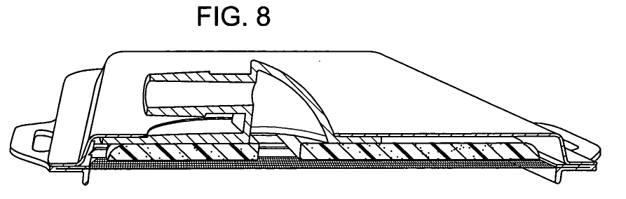

Also shown in FIGS. 5-7 as well as FIG. 8 is pre-filter assembly 14. Pre-filter assembly 14 comprises pliable surround 102, which defines barb 104 and substantially surrounds foam element 106. Also shown is mesh 108, which in conjunction with foam element 106, functions to pre-filter the influent before entering hose 16 for delivery to pump assembly 12. As described previously, pre-filter assembly 14 preferably has neutral to positive buoyancy, and mesh 108 may have hydrophilic properties to minimize entrainment of air into the system.

What is claimed:

1. A hand-held portable fluid filtration device comprising:
a housing defining an inlet portion, an outlet portion and a chamber for receiving hollow fiber media wherein the inlet portion is fluidly coupled to the outlet portion via the chamber;
at least one valve means for providing unidirectional fluid flow under normal operating conditions, operatively located between the inlet portion and the outlet portion; and
a plurality of hollow fibers disposed in the housing, at least some of which fluidly couple the inlet portion to the outlet portion.

2. The filtration device of claim 1 wherein the valve means comprises the at least some hollow fibers.

3. The filtration device of claim 1 wherein the valve means comprises one of a check valve, a reed valve or a flap valve.

4. The filtration device of claim 1 wherein at least some of the plurality of hollow fibers are hydrophobic.

5. The filtration device of claim 1 further comprising a cartridge sized to fit within at least a portion of the housing, the plurality of hollow fibers being disposed in the cartridge.

6. The filtration device of claim 6 wherein the housing comprises the cartridge.

7. The filtration device of claim 1 wherein the housing includes interface means for fluidly coupling at least a hose and a threaded container to the outlet portion.

8. The filtration device of claim 7 wherein the interface means further comprises an adaptor or bushing to permit fluidly coupling a threaded container having a diameter not accepted by the interface means.

9. The filtration device of claim 8 wherein the adaptor or bushing is detachable from the housing.

10. The filtration device of claim 1 wherein the at least one valve means can be manually directionally reversed to facilitate reverse fluid flow to back flush the device.

11. The filtration device of claim 1 wherein the at least one valve means reverses fluid flow when subject to a predetermined back pressure.

12. The filtration device of claim 1 wherein at least 80% of a maximum flow rate can be achieved when an inlet fluid pressure exceeds about 0.2 bar.
